(19) United States
(12) Patent Application Publication
(10) Pub. No.: US 2024/0147107 A1
(43) Pub. Date: May 2, 2024

(54) EARPHONE CUSHION WITH COVER FIXED TO RIGID COMPONENT TO MITIGATE VIBRATION OF THE COVER

(71) Applicant: Bose Corporation, Framingham, MA (US)

(72) Inventors: Mark Raymond Blewett, Worcester, MA (US); Liam Robert Kelly, Dorchester, MA (US)

(73) Assignee: Bose Corporation, Framingham, MA (US)

(21) Appl. No.: 18/280,034

(22) PCT Filed: Mar. 8, 2022
(86) PCT No.: PCT/US22/19245

§ 371 Date: Sep. 1, 2023

Related U.S. Application Data
(60) Provisional application No. 63/158,510, filed on Mar. 9, 2021.

(51) Int. Cl. H04R 1/10

(52) U.S. Cl. CPC H04R 1/1008

(57) ABSTRACT

Various implementations include earphone cushions and related headsets. In some aspects, an earphone cushion includes: a body having: a compressible front surface configured to engage or surround an ear of a user, an outer side surface including a compressible component and at least one rigid component, a compressible inner side surface, and a rear surface including at least one rigid component; and a cover having an outside radiating surface for contacting the ear of the user, the cover at least partially surrounding the body and including a portion that is mechanically grounded to the at least one rigid component of the outer side surface.

### PRIORITY CLAIM

This application claims priority to U.S. Provisional Patent Application No. 63/158,510 filed on Mar. 9, 2021, which is incorporated by reference in its entirety.

### TECHNICAL FIELD

This disclosure generally relates to earphones. More particularly, the disclosure relates to earphone cushions and related headsets.

### BACKGROUND

Headphones can include materials for softening the contact of the headphones against the user's ear (a supra-aural design) or against portions of the user's head adjacent to the user's ears (a circum-aural design). The materials are intended to provide comfort to the user as the headphones are used and may reduce the amount of external noise reaching the user's ear and/or may absorb noise such as audio rendered by an audio driver of the headphones that is reflected from a portion of the user's ear or head, or any reverberant sound wave within the earcushion plenum. These materials may be formed into what is referred to herein as earphone cushions, or earcushions.

In certain cases, the earphone cushion can impact the passive insertion gain (PIG) of the headphone earcup to which it belongs. For example, the material in the earphone cushion, and the acoustic energy transmitted therethrough, can impact the performance of the headphone.

### SUMMARY

All examples and features mentioned below can be combined in any technically possible way.

Various implementations include earphone cushions and related headsets. In some particular aspects, an earphone cushion includes: a body having: a compressible front surface configured to engage or surround an ear of a user, an outer side surface including a compressible component and at least one rigid component, a compressible inner side surface, and a rear surface including at least one rigid component; and a cover having an outside radiating surface for contacting the ear of the user, the cover at least partially surrounding the body and including a portion that is mechanically grounded to the at least one rigid component of the outer side surface.

In additional particular aspects, a headset includes: an earcup having a front opening configured to be adjacent to an ear of a user when worn by the user; and an earphone cushion sized to secure to the front opening of the earcup, the earphone cushion having: a body including: a compressible front surface configured to engage or surround the ear of the user, an outer side surface having a compressible component and at least one rigid component, a compressible inner side surface, and a rear surface including at least one rigid component; and a cover having an outside radiating surface for contacting a head of the user adjacent to the ear, the cover at least partially surrounding the body and having a portion that is mechanically grounded to the at least one rigid component of the outer side surface.

Implementations may include one of the following features, or any combination thereof.

In some cases, a radially facing surface of the cover is mechanically grounded to the at least one rigid component of the outer side surface.

In particular aspects, the earphone cushion further includes an adhesive coupling the cover to the at least one rigid component of the outer side surface.

In certain implementations, the body includes a material configured to compress when the earphone cushion contacts a portion of a head of the user adjacent to the ear.

In some cases, the rear surface further comprises at least one compressible component.

In particular implementations, the at least one rigid component of the outer side surface spans between the outer side surface and the rear surface.

In certain aspects, the cover includes an inner surface opposing the outside radiating surface, where the inner surface is coupled to the at least one rigid component of the outer side surface of the body.

In some cases, the inner surface is coupled to the at least one rigid component of the outer side surface by at least one of: an adhesive, heat staking, or a direct material bond.

In particular aspects, the earphone cushion further includes a densifier material contacting the inner surface of the cover, where the densifier material increases an acoustic mass of the cover during radiation of the cover.

In some cases, the densifier material includes silica gel.

In certain implementations, the densifier material is interposed between the inner surface of the cover and the outer side surface of the body.

In particular aspects, the densifier contacts a distinct portion of the inner surface of the cover than the adhesive, the heat staking, or the direct material bond.

In some cases, mechanically grounding the cover controls passive insertion gain (PIG) of a headphone earcup including the earphone cushion.

In certain aspects, the at least one rigid component at the rear surface includes an attachment mechanism at least partially embedded in the body, where the attachment mechanism includes a periphery configured to engage at least one retention element of a headphone earcup.

In particular cases, the cover includes pleather, an acrylic paint film, leather, or a composite material.

In some implementations, a stiffness of the cover along the outer side surface is equal to or greater than a stiffness of the cover along the compressible front surface.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

FIG. 1 is perspective view of a headset including an earphone according to various implementations.

FIG. 2 is a close-up perspective view of a set of earphones according to various implementations.

FIG. 3 is a partial cross-sectional view of an earphone cushion according to various implementations.

FIG. 4 is a perspective view of a portion of an earcup according to various implementations.

FIG. 5 is a perspective view of a portion of an earphone cushion according to various implementations.

FIG. 6 is a perspective view of a distinct portion of the earphone cushion in FIG. 5, according to various implementations.

FIG. 7 is a graph illustrating passive insertion gain in an earphone according to various example implementations.

FIG. 8 is partial cross-sectional view of an earphone cushion according to various additional implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that a cover for an earphone cushion can be mechanically grounded to mitigate vibration of the cover material, and in some cases, control the passive insertion gain (PIG) of a headphone earcup employing the cushion.

As noted herein, in certain cases, the earphone cushion can impact the passive insertion gain (PIG) of the headphone earcup to which it belongs. For example, the material in the earphone cushion, and the acoustic energy transmitted therethrough, can impact the performance of the headphone. Various implementations include an earphone cushion that has a body with a compressible front surface for engaging or surrounding a user's ear. The body also has an outer side surface that includes a compressible component and a rigid component. A cover at least partially surrounds the body and is positioned to contact the user's head, e.g., at the ear or around the ear. The cover is mechanically grounded to the rigid component of the outer side surface of the body, mitigating vibration of the cover and controlling the passive insertion gain of the headphone. In various implementations, the mechanically grounded cover enhances the passive insertion gain of the headphone as compared with conventional headphones, e.g., in frequencies around 500 Hertz (Hz) to around 2 kHz, with particular benefits around 1 kHz.

Commonly labeled components in the FIGURES are considered to be substantially equivalent components for the purposes of illustration, and redundant discussion of those components is omitted for clarity. Numerical ranges and values described according to various implementations are merely examples of such ranges and values, and are not intended to be limiting of those implementations. In some cases, the term “approximately” is used to modify values, and in these cases, can refer to that value+/−a margin of error, such as a measurement error, which may range from up to 1-5 percent.

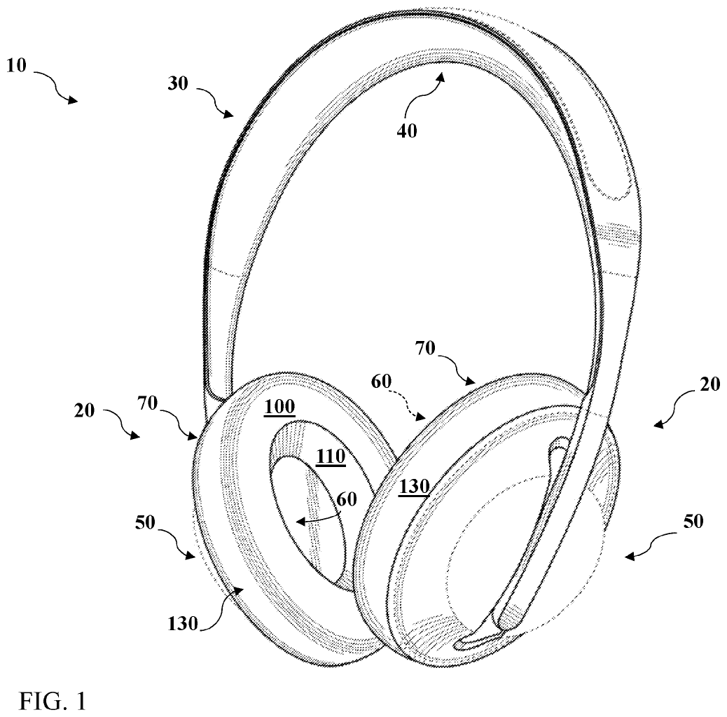

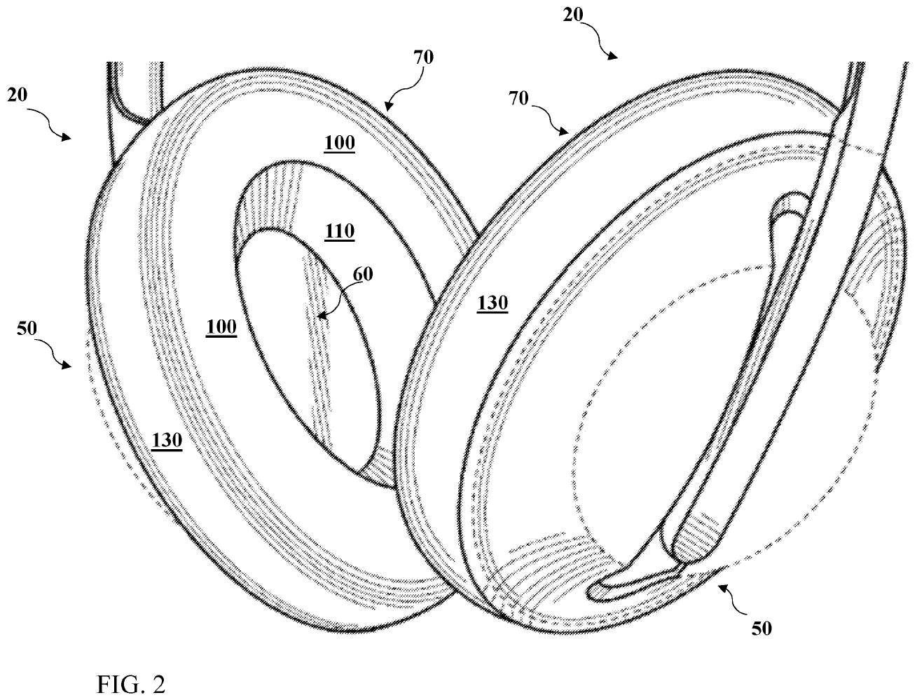

FIG. 1 depicts an audio device, including a headset 10 according to various implementations. FIG. 2 shows a close-up perspective of a portion of the headset 10 in FIG. 1. These FIGURES are referred to concurrently. In this example, the headset 10 is illustrated as a pair of around-ear headphones. However, it is understood that principles of the disclosed implementations can be applied to on-ear headphones in various implementations. Headset 10 can include a pair of earpieces (or, earphones) 20 configured to fit over the ear, or on the ear, of a user. A headband 30 spans between the pair of earphones 20 and is configured to rest on the head of the user (e.g., spanning over the crown of the head or around the head). The headband 30 can include a head cushion 40 in some implementations. Stored within one or both of the earphones 20 are electronics and other components for controlling audio output at the headset 10 (not shown).

Each earphone 20 can include an earcup 50 having a front opening 60 (one visible in this view) configured to be adjacent to an ear of a user when worn by the user. Each earphone 20 also includes an earphone cushion (or simply, cushion) 70 sized to secure to the front opening 60 of the earcup 50. In various implementations, the earphone cushion 70 is configured to surround a user's ear (e.g., a circum-aural design) during use of the headset 10, e.g., to contact a portion of the user's head adjacent to the ear. However, in other implementations, the earphone cushion 70 can be configured to rest on at least a portion of the user's ear (e.g., a supra-aural design).

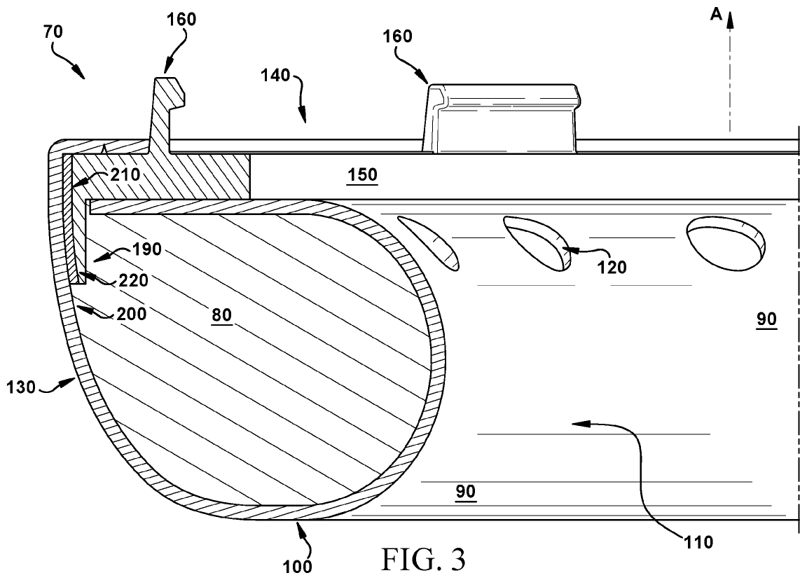

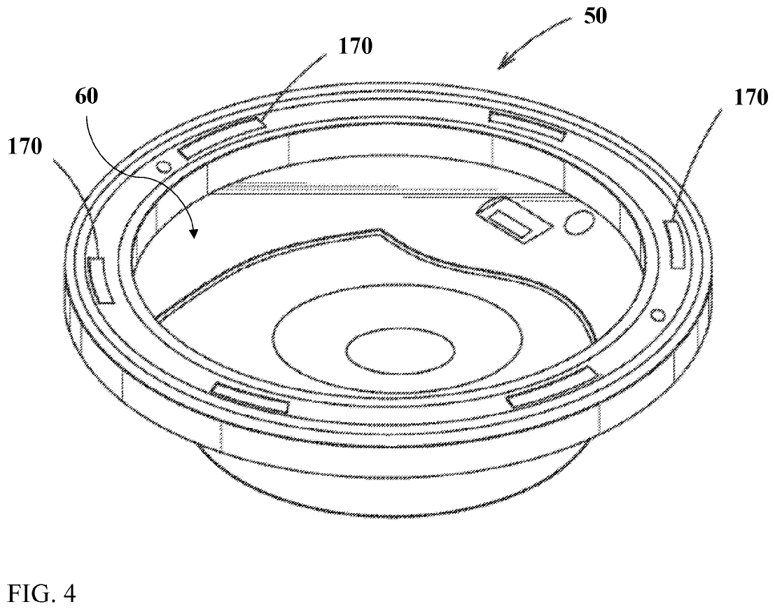

FIG. 3 illustrates additional features of the cushion 70 separated from the earcup 50, in a cross-sectional depiction. FIG. 4 is a perspective view of the earcup 50, separated from the cushion 70. In FIG. 3, the cushion 70 is shown including a body 80, which is at least partially surrounded by a cover 90. In various implementations, the body 80 includes a material configured to compress when the earphone cushion 70 contacts a portion of a head of the user adjacent to the ear. In certain examples, the body 80 can include or consist of a bulk, or inner portion, and an outer surface. Both may include or consist of a polyurethane foam and/or another type of compliant material. The material of the bulk of the body 80 may be a partially reticulated polymer foam having cell sizes within the bulk of the body 80 with diameters of between about 100 μm and about 750 μm. The cell size at the outer surface of the body 80 may be smaller than that in the bulk of the body 80, for example, with diameters of between about 25 μm and about 100 μm. When uncovered by another material, the outer surface of the body 80 may be at least partially acoustically transparent to allow sound waves to pass through the outer surface and into the bulk of the body 80. The body 80 may allow air to flow through at a rate of about 10 cm³/cm² second or less and may have an acoustic dampening peak at between about 1 kHz and about 2.5 kHz. Other examples of materials in the body 80 are described in U.S. Pat. Nos. 10,187,716 and 10,659,861, each of which is incorporated by reference in its entirety.

The cover 90 is configured to fit snugly around the body (or, core) 80 and in use, has an outside radiating surface that is configured contact the user's ear and/or a portion of the user's head adjacent to the ear. In certain implementations, the cover 90 includes one or more of: pleather, an acrylic paint film, leather, or a composite material. Other examples of materials in the cover 90 are described in U.S. Pat. Nos. 10,187,716 and 10,659,861, each of which is incorporated by reference in its entirety. In particular examples, the cover 90 includes pleather, leather or a composite material. According to particular implementations, the cover 90 is formed of pleather in a single piece, e.g., sheet, and is wrapped around portions of the body 80 during manufacture of the ear cushion 70.

With reference to FIGS. 1-3, in particular cases, the earphone cushion 70 has a front surface 100 that is configured to engage or surround the ear of the user. The front surface 100 is configured to contact the user's head adjacent to the ear in the circum-aural design, or directly contact the user's ear in a supra-aural design. The front surface 100 is compressible. That is, the front surface 100 will compress when pressed to contact the user's ear or head adjacent to the ear. The inner side surface 110 is also compressible in various implementations, and in certain cases, the cover 90 over the inner side surface 100 includes at least one aperture (or, perforation) 120 for enhancing air exchange and/or cooling between the space defined by the front opening 60 (FIG. 2) and the body 80. When an earphone 20 is worn by the user, the inner side surface 110 is hidden from view, and may contact or surround the user's ear. In certain cases, at least a portion of the outer side surface 130 is visible when the earphone 20 is worn by the user.

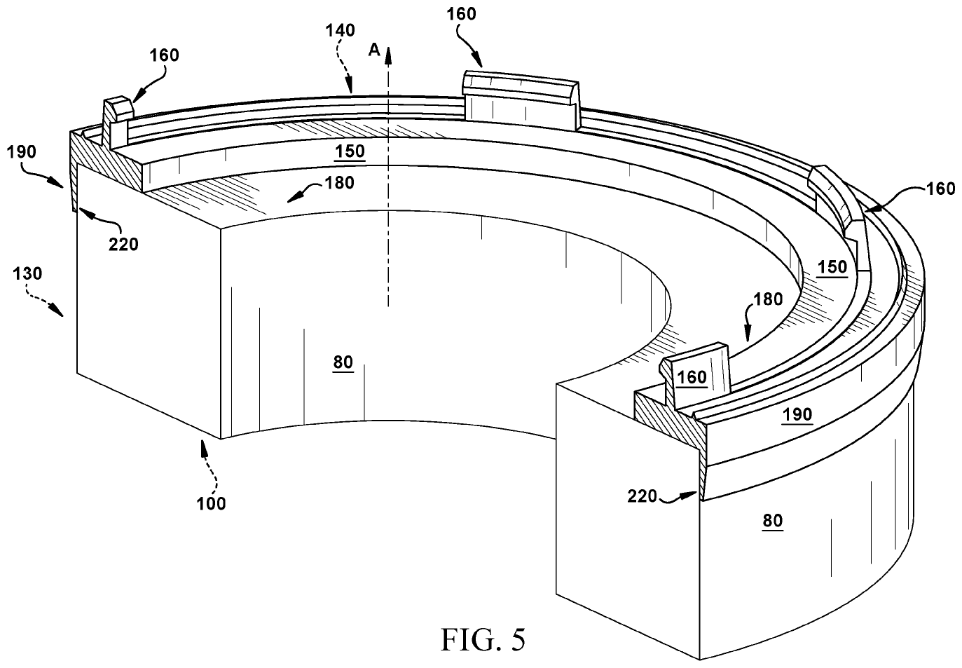

In various implementations, a rear surface 140 (FIG. 3) of the cushion 70 includes at least one rigid component 150. In certain cases, the rigid component 150 includes at least one coupler 160 for mating with a complementary retention element 170 in the earcup 50 (FIG. 4). In some implementations, the rigid component 150 includes one or more segments (e.g., arcuate segments). However, in other implementations, the rigid component 150 includes a unitary, or nearly unitary annular mount, e.g., an attachment mechanism such as a snap ring. In the example implementations where the rigid component 150 includes an attachment mechanism (e.g., snap ring), the coupler(s) 160 include one or more peripheries, or prongs (e.g., including a hook, ridge, or male/female coupler, etc.) for mating with the complementary retention element (or, coupler) 170 in the earcup 50 (FIG. 4). In certain cases, the couplers 160, 170 can include male/female couplers, and can be rearranged according to any effective configuration for mating the rigid component 150 with the coupler(s) 170. In addition to the rigid component 150, the rear surface 140 can also include at least one compressible component 180, e.g., a portion of the body 80 (seen in isolation view in FIG. 5). In some cases, a portion of the cover 90 wraps around the inner side surface 110 to the rear surface 140, and is coupled with the rigid component 150 along the rear surface 140. In certain cases, the cover 90 is coupled to the at least one rigid component 150 along the rear surface 140 by at least one of: an adhesive, heat staking, or a direct material bond. In some cases, the cover 90 is press-fit into one or more slots or grooves in the rigid component 150 (visible in isolation view in FIG. 5).

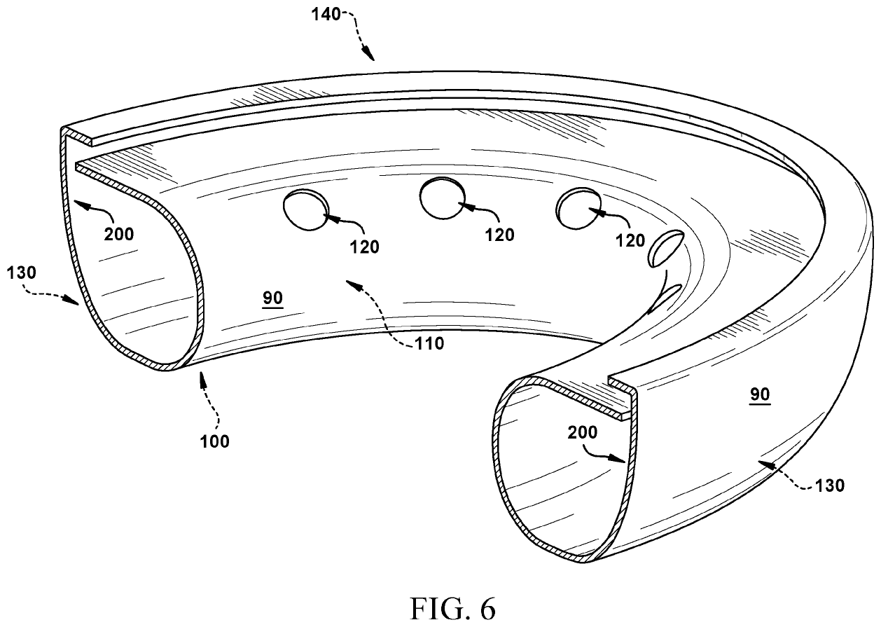

As shown in FIG. 3, and also illustrated in the isolated perspective views of the body 80 (FIG. 5) and the cover 90 (FIG. 6), the outer side surface 130 has both a compressible component (e.g., compressible body material) and at least one rigid component 190. In certain cases, the rigid component 190 is part of rigid component 150, e.g., an axial extension of the snap ring or snap ring segment. In these cases, the rigid component 150 spans between the rear surface 140 and the outer side surface 130. In other cases, the rigid component 190 can be separate from rigid component 150 and coupled to rigid component 150 within the assembled cushion 70. In various implementations, the cover 90 wraps around a portion of the rigid component 190, and is mechanically grounded to the rigid component 190 at the outer side surface 130. That is, in certain cases such as illustrated in FIG. 3 and FIG. 6, the cover 90 wraps around the rigid component 190 and is coupled with rigid component 190 at the rear surface 140. In certain cases, the cover 90 is coupled to the at least one rigid component 150 along the rear surface 140 by at least one of: an adhesive, heat staking, or a direct material bond. According to various implementations, the cover 90 is coupled to the rigid component 150 at the rear surface 140. Additionally, and in contrast to conventional ear cushions, the cover 90 is mechanically grounded to the rigid component 190 along the outer side surface 130. That is, a radially facing surface 200 of the cover 90 (e.g., FIG. 3, FIG. 6) is mechanically grounded to the rigid component 190 of the outer side surface 130. In particular cases, the cover 90 is mechanically grounded to the rigid component 190 at the outer side surface 130 with a coupling 210. In some cases, the coupling 210 includes an adhesive. In other cases, the coupling 210 includes at least one of: an adhesive, heat staking, or a direct material bond. In these cases, as illustrated in FIG. 3, the inner surface of the cover 90 can be mechanically grounded to the rigid component 190 via the coupling 210. In various implementations, the coupling 210 extends an entire, or nearly an entire axial length of the rigid component 190 (e.g., along axial direction A). In some cases, the rigid component 190 has a taper or narrowing feature 220 along the axial direction (A) moving away from the rigid component 150, e.g., to facilitate wrapping of the cover 90 around the rigid component 190.

In various implementations, the stiffness of the cover 90 along the outer side surface 130 is greater than a stiffness of the cover 90 along the (compressible) front surface 100. Additionally, mechanically grounding the cover 90 controls the passive insertion gain of a headphone earcup 50 that includes the cushion 70.

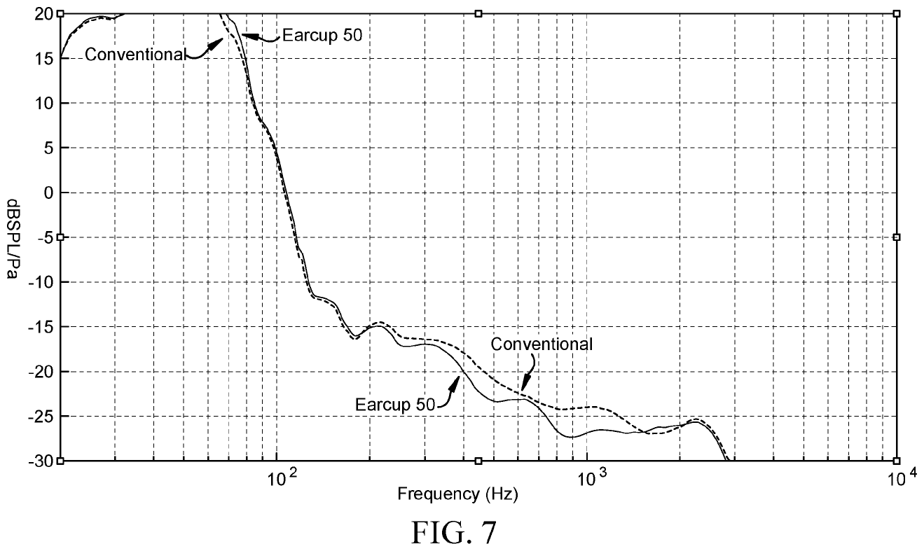

FIG. 7 is graphical illustration of the passive insertion gain (as dBSPL/Pa v. Frequency(Hz)) of the earcup 50 as compared with a conventional earcup in some example implementations. The conventional earcup has a cushion in which its cover is not mechanically grounded to a rigid component at the outer side surface. As illustrated in FIG. 7, in various implementations, the mechanically grounded cover enhances the passive insertion gain of the headphone as compared with conventional headphones, e.g., in frequencies around 500 Hertz (Hz) to around 2 kHz, with particular benefits around 1 kHz.

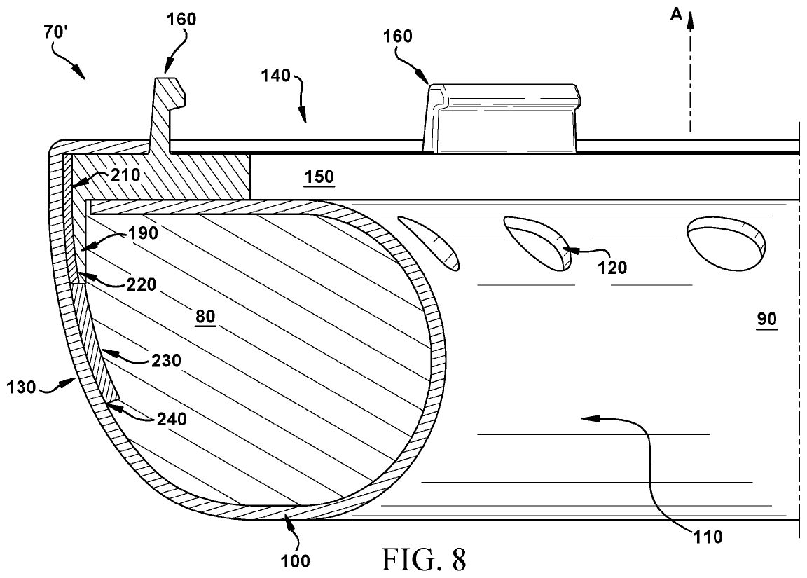

FIG. 8 illustrates an additional implementation of an earphone cushion 70′, which is similar to earcup 50 (FIGS. 1-6), but further includes a densifier material 230 contacting the inner surface of the cover 90. According to various implementations, the densifier material 230 includes a gel. In certain cases, the densifier material 230 includes silica gel. In certain additional implementations the densifier material 230 includes tungsten. The densifier material 230 can be directly coupled (e.g., bonded) to the inner surface of the cover 90 in some implementations. In certain additional implementations, the densifier material 230 includes at least two layers disposed along the inner surface of the cover 90. In particular cases, e.g., as illustrated in FIG. 8, the densifier material 230 contacts the inner surface of the cover 90 along an interface between the cover 90 and the material of the body 80. In other terms, the densifier material 230 is interposed between the inner surface of the cover 90 and the outer side surface of the body 80. According to some example implementations, the densifier material 230 contacts a distinct portion 240 of the inner surface of the cover 90 than the coupling 210 (e.g., adhesive, heat staking, or direct material bond). In particular cases, the densifier material 230 is adjacent the coupling 210, and in more particular cases, the densifier material 230 abuts or otherwise contacts the coupling 210. According to various implementations, the densifier material 230 (e.g., when coupled to the cover 90) increases an acoustic mass of the cover 90 during radiation of the cover 90.

While various components in the earcup(s) 50 are described as separate, it is understood that one or more components of the earcup(s) 50 can be formed as a unitary component, i.e., formed as a single component, such as through an additive manufacturing process, casting, molding, etc. In other cases, components can be is composed of separately formed parts that are bound together, e.g., with adhesive, heat staking, bonding, or via direct couplers or fasteners such as pins, clips, screws, etc.

As noted herein, in contrast to conventional headsets, the headsets disclosed according to implementations can include earcups with a cover that is mechanically grounded to the rigid component of the outer side surface of the body, mitigating vibration of the cover and controlling the passive insertion gain of the headphone. In various implementations, the mechanically grounded cover enhances the passive insertion gain of the headphone as compared with conventional headphones, e.g., with particular benefits around 1 kHz. The headsets disclosed according to various implementations also maintain a desirable acoustic volume in the front cavity (i.e., surrounding the user's ear), providing acoustic performance benefits. These headsets retain the comfort of a larger, softer ear cushion such as those found in conventional headsets, while reducing the undesirable vibration of the cover and associated passive insertion gain issues in those conventional headsets. Additionally, the headsets disclosed according to various implementations can also maintain the sometimes desirable (e.g., comfortable) appearance of a plush ear cushion, as perceived by the user.

One or more components in the electronic devices described herein can be formed of any conventional electronic device material, e.g., a heavy plastic, metal (e.g., aluminum, or alloys such as alloys of aluminum), composite material, etc. It is understood that the relative proportions, sizes and shapes of the transducer(s) and components and features thereof as shown in the FIGURES included herein can be merely illustrative of such physical attributes of these components. That is, these proportions, shapes and sizes can be modified according to various implementations to fit a variety of products.

In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding).

A number of implementations have been described. Nevertheless, it will be understood that additional modifications may be made without departing from the scope of the inventive concepts described herein, and, accordingly, other implementations are within the scope of the following claims.

We claim:

1. An earphone cushion, comprising:
a body comprising: a compressible front surface configured to engage or surround an ear of a user, an outer side surface comprising a compressible component and at least one rigid component, a compressible inner side surface, and a rear surface comprising at least one rigid component; and
a cover having an outside radiating surface for contacting the ear of the user, the cover at least partially surrounding the body and comprising a portion that is mechanically grounded to the at least one rigid component of the outer side surface.

2. The earphone cushion of claim 1, wherein a radially facing surface of the cover is mechanically grounded to the at least one rigid component of the outer side surface.

3. The earphone cushion of claim 1, further comprising an adhesive coupling the cover to the at least one rigid component of the outer side surface.

4. The earphone cushion of claim 1, wherein the body comprises a material configured to compress when the earphone cushion contacts a portion of a head of the user adjacent to the ear.

5. The earphone cushion of claim 1, wherein the rear surface further comprises at least one compressible component.

6. The earphone cushion of claim 1, wherein the at least one rigid component of the outer side surface spans between the outer side surface and the rear surface.

7. The earphone cushion of claim 1, wherein the cover comprises an inner surface opposing the outside radiating surface, wherein the inner surface is coupled to the at least one rigid component of the outer side surface of the body.

8. The earphone cushion of claim 7, wherein the inner surface is coupled to the at least one rigid component of the outer side surface by at least one of: an adhesive, heat staking, or a direct material bond.

9. The earphone cushion of claim 7, further comprising a densifier material contacting the inner surface of the cover, wherein the densifier material increases an acoustic mass of the cover during radiation of the cover.

10. The earphone cushion of claim 9, wherein the densifier material comprises silica gel.

11. The earphone cushion of claim 9, wherein the densifier material is interposed between the inner surface of the cover and the outer side surface of the body.

12. The earphone cushion of claim 11, wherein the densifier contacts a distinct portion of the inner surface of the cover than the adhesive, the heat staking, or the direct material bond.

13. The earphone cushion of claim 1, wherein mechanically grounding the cover controls passive insertion gain (PIG) of a headphone earcup comprising the earphone cushion.

14. The earphone cushion of claim 1, wherein the at least one rigid component at the rear surface comprises an attachment mechanism at least partially embedded in the body, wherein the attachment mechanism comprises a periphery configured to engage at least one retention element of a headphone earcup.

15. The earphone cushion of claim 1, wherein the cover comprises pleather, an acrylic paint film, leather, or a composite material.

16. The earphone cushion of claim 1, wherein a stiffness of the cover along the outer side surface is equal to or greater than a stiffness of the cover along the compressible front surface.

17. A headset comprising:
an earcup having a front opening configured to be adjacent to an ear of a user when worn by the user; and
an earphone cushion sized to secure to the front opening of the earcup, the earphone cushion comprising:
a body comprising: a compressible front surface configured to engage or surround the ear of the user, an outer side surface comprising a compressible component and at least one rigid component, a compressible inner side surface, and a rear surface comprising at least one rigid component; and
a cover having an outside radiating surface for contacting a head of the user adjacent to the ear, the cover at least partially surrounding the body and comprising a portion that is mechanically grounded to the at least one rigid component of the outer side surface.

18. The headset of claim 17, wherein a radially facing surface of the cover is mechanically grounded to the at least one rigid component of the outer side surface.

19. The headset of claim 17, wherein the cover comprises an inner surface opposing the outside radiating surface, wherein the inner surface is coupled to the at least one rigid component of the outer side surface of the body, wherein the inner surface is coupled to the at least one rigid component of the outer side surface by at least one of: an adhesive, heat staking, or a direct material bond.

20. The headset of claim 19, further comprising:
a densifier material contacting the inner surface of the cover,
wherein the densifier material increases an acoustic mass of the cover during radiation of the cover, wherein the densifier material is interposed between the inner surface of the cover and the outer side surface of the body and contacts a distinct portion of the inner surface of the cover than the adhesive, the heat staking, or the direct material bond.

21. The headset of claim 17, wherein the at least one rigid component of the outer side surface spans between the outer side surface and the rear surface.

22. The headset of claim 17, wherein mechanically grounding the cover controls passive insertion gain (PIG) from the headset, and wherein a stiffness of the cover along the outer side surface is equal to or greater than a stiffness of the cover along the compressible front surface.
